(19) United States
(12) Patent Application Publication
(10) Pub. No.: US 2004/0127289 A1
(43) Pub. Date: Jul. 1, 2004

(54) System and method for combining automatic opponent matching for computer gaming with chat room searchers

(75) Inventors: J. Michael Davis, Renton, WA (US); Matthew J. Feldman, Issaquah, WA (US); Bernard John Johansen II, Carlsbad, CA (US)

Correspondence Address: GREENBERG-TRAURIG, 1750 TYSONS BOULEVARD, 12TH FLOOR, MCLEAN, VA, 22102, US

(73) Assignee: Versaly Games, Inc., Issaquah, WA

(21) Appl. No.: 10/637,048

(22) Filed: Aug. 8, 2003

Related U.S. Application Data
(60) Provisional application No. 60/401,801, filed on Aug. 8, 2002.
(60) Provisional application No. 60/401,800, filed on Aug. 8, 2002.

(51) Int. Cl. G06F 17/00; G06F 19/00

(52) U.S. Cl. 463/42

(57) ABSTRACT

A system and methods through which chat room participants can be automatically matched with prospective game opponents to facilitate game play. The invention can take factors such as player language, player skill level, and player location into account as opponents are assigned to games, and can match prospective players participating in a chat room with other prospective opponents not participating in the chat room.

This application is related to, and claims the benefit of, U.S. Provisional Patent Application Serial No. 60/401,801, filed Aug. 8, 2002, the teachings of which are incorporated herein by reference in their entirety. This application is also related to, and claims the benefit of, U.S. Provisional Patent Application Serial No. 60/401,800, filed Aug. 8, 2002, the teachings of which are incorporated herein by reference in their entirety. This application is further related to the U.S. Provisional Application entitled “System and Method for Automatically Finding Gaming Partners Based on Pre-Established Criteria” filed on even date herewith by the inventors of the present invention, the teachings of which are included herein by reference in their entirety.

### FIELD OF THE INVENTION

The present invention relates to the field of computer gaming and, more specifically, the present invention provides a system and methods for selecting one or more gaming partners to play a game with or against a player.

### BACKGROUND OF THE INVENTION

Computer games have been around for many years, allowing players to play games from those as simple as Pong to advanced flight and combat simulators. While many computer games are intended to be played by a single player, most players find it more exciting to play against a human or computer opponent. Thus, computer game manufacturers have found an ever-increasing market for multiplayer games. Initially, such multiplayer games were played by two or more players on the same computer, game console, or other such gaming device.

As technology has advanced, players need no longer be on the same gaming device, or even in the same room. Some of the first remote multiplayer games used telephone lines and modems to connect two or more gaming devices through a “dedicated” connection between the devices. While dedicated connections did allow for multiplayer games, dedicated connections had the potential to be very expensive, especially when long distance or other telephone charges were applied. Another disadvantage of dedicated connections is that players must always know with whom they are playing, and need to negotiate a playing time and game in advance. It should be noted that variations on the direct connection method persist even with modem Internet technology. However, in place of phone numbers, players exchange network identity information, such as Internet Protocol (IP) addresses.

As the Internet has become more widely adopted, several World Wide Web sites were created which allowed players to play multiplayer games against friends or strangers whenever they want and without the costs associated with dedicated connections. These World Wide Web sites are commonly referred to as “game lobbies”. In a game lobby, people access a site devoted to a particular game, such as Starcraft, published by Blizzard Entertainment of Irvine, Calif., or Myth, published by Bungie Studios of Redmond, Wash., or type of game (e.g. http://games.yahoo.com for board and card games). Game lobbies usually have hundreds of people playing individual games simultaneously, with players typically playing a game from start to finish, and playing games with structured starting and ending points.

Game lobbies also frequently implement some organizational structure to allow quick access to games of interest. Given that players frequently like to talk before or after a game, most game lobbies implement their organization as formal parts of a chat room. For example, games.yahoo.com has Beginner, Intermediate and advanced “sub”-chat rooms for chess, bridge, and the like. Others are less structured, such as http://www.Battle.net, a web site for Starcraft, where players frequently name their games with phrases like “newbies only”. However, both of these methods are largely voluntary. Thus, advanced players can play games in Beginner rooms at games.yahoo.com and advanced players can create and “advertise” a game as a “newbies only” game on Battle.net.

In an attempt to make games more fair, some lobbies have begun tracking player information. Such information may be voluntarily submitted by the player, for example, skill level at chess, or the information may be determined by a lobby from a game, such as player rating in Starcraft. Most lobbies implementing such tracking systems allow would-be opponents or teammates to view this information before agreeing to play a game.

While access to player information can be advantageous for other players, lobbies currently implement player information tracking and information display systems in a manner that requires a large display device to manage the information successfully. In addition, the voluntary nature of much of this information makes it inherently unreliable, and many players have come to disregard it. People can lie about their skill level and even their identity because users log into these sites in a manner independent from their primary Internet identity or other common identifier.

Game lobbies are not the only method through which players meet for multiplayer games. Another common multiplayer meeting system utilizes real time servers. Real time servers are typically used for games whose beginning and ending points are less structured, such as “repeating one-shot games” and “persistent worlds”. Persistent world games are also known as multi-user dungeons, or MUDs. Examples of these persistent world games include Everquest, produced by Sony Online Entertainment, Inc. of San Diego, Calif.; and Ultima Online, produced by Electronic Arts, Inc. of Redwood City, Calif. These games run constantly, and players frequently have some permanent asset or assets located in the game whether they are currently playing or not. Real time servers supporting these games typically do not allow team member or Automatic Opponent Matching, primarily because opponents and team members may come and go as the game is played without causing the game to cease.

Repeating one-shot games are frequently multiplayer first-person-shooters like Quake, produced by Id Software, Inc., of Tex.; Tribes, produced by Sierra Entertainment, Inc. of Bellevue, Wash.; and Half-Life, also produced by Sierra Entertainment, Inc. Some real time servers supporting these games may implement chat rooms as described above, but many simply display a list of games in progress and allow people to drop in and out of the game at will. These games typically involve two teams of people playing a “cops and robbers” or other team-based adversarial style scenario and if occasionally there are more members of one team than the other, the game does not suffer for it. Again, like persistent worlds, the player has little direct choice in who his opponents are. It is possible for players of these games to devise a method similar to the direct connection technique described above, such as connecting to the same server at the same time, to ensure they are playing with people they like, but these game servers typically do not allow for any more advanced teammate or opponent selection techniques.

As with game lobbies, the user interfaces generated by real time game servers supporting repeating one-shot games and persistent worlds are frequently designed for fairly high resolution displays with large display areas. Neither game lobbies nor real time game servers are currently designed to accommodate the increasing number of portable game devices, such as portable digital assistants (PDAs), cellular telephones, and the like. These devices typically provide only limited display areas and displays with relatively limited resolutions.

### SUMMARY OF THE INVENTION

Accordingly, the present invention is directed to a system and method for combining Automatic Opponent Matching for computer gaming with chat room searchers that substantially obviates one or more of the problems due to limitations and disadvantages of the related art.

An object of the present invention is to allow servers supporting chat room style game participant searching to interoperate with servers supporting Automatic Opponent Matching.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

Multi-player games are becoming available on a wide variety of devices. Many of these devices are small hand held devices with accordingly small displays. As these devices connect to the Internet there comes the ability to play multi-player games with strangers. Most methods for finding opponents in online games require a large display terminal to display the universe of opponents, however these techniques will not work efficiently on devices with a small display area. The present invention allows traditional chat rooms to interoperate with Automatic Opponent Matching to provide enhanced opponent search methods. As used herein, the term opponent is intended to be connote another player in a game, and should not be construed as limiting the present invention to selection of players whose relationship to a player of interest is adversarial in nature.

Automatic Opponent Matching, as described in the above-referenced U.S. Provisional Patent Application entitled “System and Method for Automatically Finding Gaming Partners Based on Pre-Established Criteria”, utilizes at least two sets of information to match opponents, a player's identity information and a player's opponent profile. Traditional gaming chat rooms do not distinguish between these two sets of criteria. The present invention extracts these two sets of criteria from available chat room information and, in conjunction with Automatic Opponent Matching, allows chat room players and Automatic Opponent Matching players to find and play games with each other.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating a preferred hardware architecture for implementing the present invention, suitable for local and distance-based gaming.

FIG. 2 is a block diagram illustrating an alternative hardware architecture for implementing the present invention, suitable for local gaming.

FIG. 3 is a block diagram illustrating another alternative hardware architecture for implementing the present invention, suitable for server-less local gaming.

FIG. 4 is a block diagram illustrating a language determination algorithm.

### DETAILED DESCRIPTION OF THE PREFERRED EMBODIMENT

Reference will now be made in detail to the preferred embodiments of the present invention, examples of which are illustrated in the accompanying drawings.

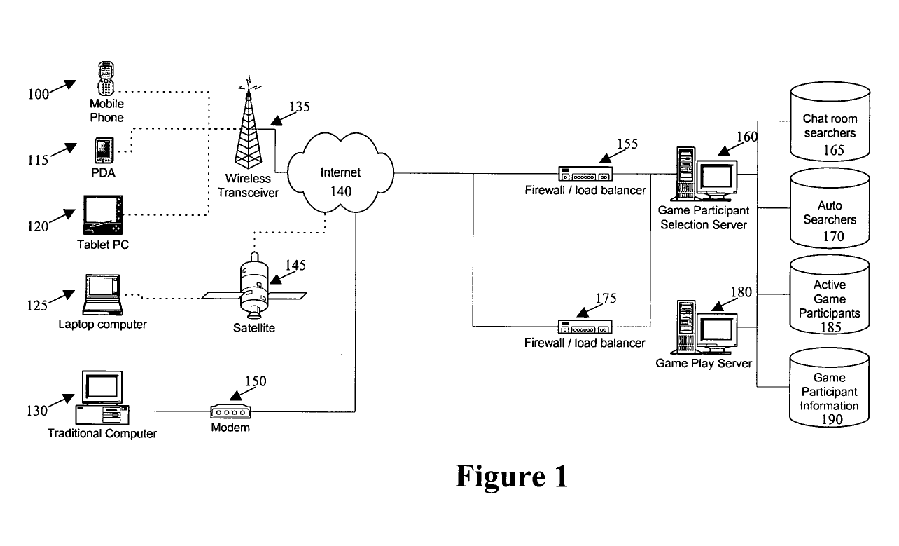

FIG. 1 is a block diagram illustrating a preferred hardware architecture for implementing the present invention which is suitable for both local and distance-based gaming. As FIG. 1 illustrates, a preferred embodiment of the present invention uses two databases, referred to herein as chat room searchers 165 and auto searchers 170, as part of game participant selection server 160. While the present invention utilizes individual databases for chat room searchers 165 and auto searchers 170, it should be apparent to one skilled in the art that alternative embodiments, including incorporating chat room searchers 165 and auto searchers 170 as individual tables within the same database, can be employed without departing from the spirit or the scope of the present invention.

The present invention preferably maintains game participant information, including game participant preferences, in a database, illustrated as game participant information 190 in FIG. 1. Information preferably tracked in game participant information 190 includes, but is not limited to, Personal Information, Skill Level, Location, Language, Buddy lists, and Blocked lists. Additional information tracked in a preferred embodiment of game participant information 190, including specific field names, is provided below. While specific field names and preferred values for some fields are described below, it should be appreciated by one skilled in the art that field names, preferred values, and the like can be easily changed, and additional fields and/or values substituted therefor, without departing from the spirit or the scope of the invention. Information tracked in game participant information 190 is used, for example, to assist game participant selection server 160 in selecting one or more opponents to participate in a game with a game participant.

When game participant selection server 160 is in what is referred to as a “stable configuration”, chat room searchers 165 and auto searchers 170 may contain one or more partially filled game-tables, or benches (defined below), of would-be game participants who collectively are not interested in playing a specific game with each other. This configuration is referred to as “stable” because game participant selection server 160 is awaiting the arrival of one or more game participants who can complete a bench, thus necessitating further action. Once a game bench is filled with opponents that are mutually interested in playing a specific game with each other, that bench is preferably removed from auto searches 170 and/or chat room 165 and is transferred to game play server 180.

Most of the game participant matching work occurs when a new game participant joins, or announces his or her availability to, the system and indicates the game or games in which the game participant desires to participate. A small amount of work may also occur when a participant leaves the system. A game participant joins the system by initially connecting to game participant selection server 160 which, according to a preferred embodiment of the present invention, causes the game participant to be added to both auto searchers 170 and chat room searchers 165. In an alternative embodiment, determination of whether a game participant joining the system is added to auto searches 170, chat room searchers 165, or both databases is determined based on the type of device which the game participant is using. In still another embodiment, such a determination may be based on game participant preferences, with such preferences stored in game participant information 190.

A game participant may connect to the present invention using wireless devices, such as mobile phone 100, PDA 115, tablet PC 120, and laptop computer 125, or the connection may be established via a wired device, such as traditional computer 130. Connectivity between game participant selection server 160 and a wireless device may be provided by wireless transceiver 135, such as, but not limited to, one supporting the Institute of Electrical and Electronics Engineers (IEEE) standards 802.11b and/or 802.11g, BlueTooth, cellular digital packet data (CDPD), general packet radio service (GPRS), or other such telecommunications standards; satellite 145; or other wireless means, where such wireless means provides access to Internet 140 or another, preferably high speed, telecommunications network. Connectivity between game participant selection server 160 and Internet 140 may also be provided through a wired means, such as via dial-up or high speed modem 150.

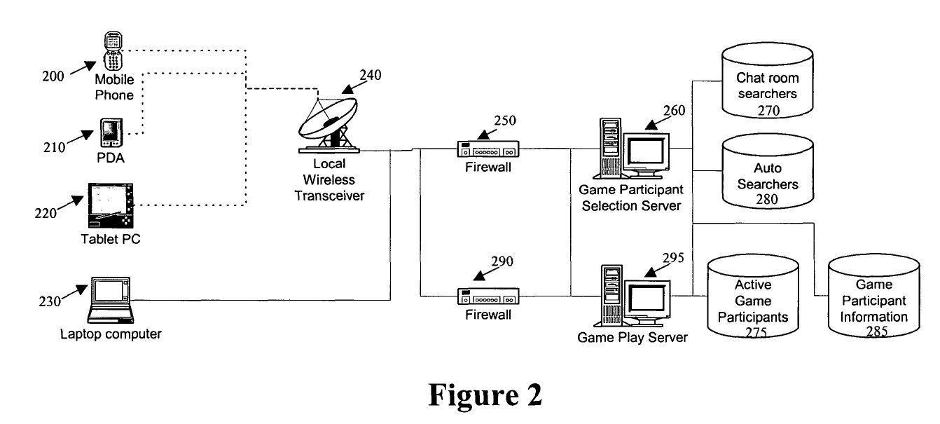

While the system and methods described herein have been specifically designed to allow game participants to connect to the system from anywhere in the world, it should be apparent to one skilled in the art that the present invention can be readily adapted to provide more limited connectivity. By way of example, without intending to limit the present invention, FIG. 2 illustrates an architecture through which the present invention can be implemented to work in a coffee shop, cyber café, shopping mall game room, airplane, bus, cruise ship, or other such location. Such an embodiment may be advantageous where a game participant prefers, or is forced, to be in the same physical location as other participants, but would like to use the game participant's own equipment or would like to engage strangers in games.

The embodiment illustrated in FIG. 2 preferably utilizes a wireless communication link between a game participant's game equipment, illustrated as mobile phone 200, PDA 210, and tablet PC 220, and game participant selection server 260 via a local transceiver. However, as illustrated by the connection between laptop computer 230 and Firewall 290, wired communications may also be utilized.

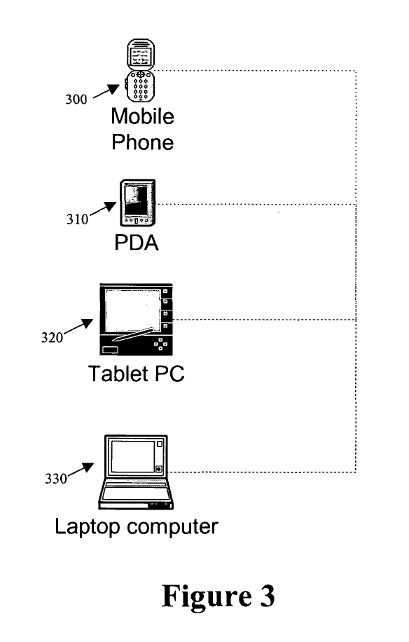

FIGS. 1 and 2 illustrate server-based architectures for deploying the present invention. However, it should be apparent to one skilled in the art that a distributed computing architecture can also be utilized to support the present invention. Distributed computing architectures are typically serverless, with each computer or other device participating therein preferably performing some of the processing necessary to support the system. Such a system is illustrated in FIG. 3. In the illustrated embodiment, mobile phone 300, PDA 310, tablet PC 320, and laptop computer 330 are communicating with each other via a wireless communications protocol, such as BlueTooth or IEEE 802.11b, although wired connectivity can be easily supported. Each device runs special software that enables the device to share the processing overhead necessary to support the present invention without unduly burdening a given device. Such a system allows ad-hoc multiplayer gaming in areas where connectivity to a server or to the Internet is cost prohibitive or otherwise unavailable.

The description included herein generally describes the architecture illustrated in FIG. 1, and specifically focuses on the interaction of chat room searchers 165 and auto searchers 170. However, it should be apparent to one skilled in the art that the invention can be adapted to work with alternative architectures, including, but not limited to, those illustrated in FIGS. 2 and 3.

Auto-Searcher Interoperating with Room Searcher

Automatic Opponent Matching uses two sets of parameters when matching opponents, identity information, or who the player is, and an opponent profile, or the characteristics the player prefers in an opponent. To allow chat rooms to interoperate with Automatic Opponent Matching, it is advantageous to extract these two parameter sets from the information available to a chat room system.

Chat room users typically must be registered subscribers. In a preferred embodiment, the information subscribers provide during registration is similar to information used by Automatic Opponent Matching. The challenge, however, lies in extracting opponent profile information from a chat room system. To understand the difficulty, some background on chat rooms may be helpful.

The rooms within a gaming chat room area are usually divided into various categories, the most common being skill level. Typically an online gaming chat room area has rooms for Beginners, Intermediates, and Experts. Usually these include players worldwide (i.e. there is no location restriction). Sometimes the population within a room exceeds the system's capacity, and an additional room or rooms, such as a Beginner-2 room, is created.

Those additional rooms are frequently necessary because entry to the rooms is not controlled, or policed. That is to say, players of Expert skill level are free to enter Beginner's rooms and play against opponents there. Thus, a Beginners room can be seen as having ambiguous meaning; it could mean that A) a player entering the room is himself a Beginner, or that B) the player entering the room wishes to play against Beginners.

Automatic Opponent Matching allows players of a given skill level, such as Beginner, to choose to play against players of a range of skill levels, preferably Beginner, Intermediate, and Expert skill. Players can control the skill level of their opponents by specifying a range of opponent skills they consider desirable. The only restriction preferably imposed by Automatic Opponent Matching is that the opponent skill level or range of skill levels specified by a player must include the player's own skill level. Thus,in a preferred embodiment, a Beginner cannot say he's looking for Experts-only, but can say he is interested in players of Beginner thru Expert skill level.

To allow chat rooms to interoperate with Automatic Opponent Matching, a method of determining compatible opponent profile information is needed. In addition, methods integrating chat room players in Automatic Opponent Matching searches are advantageous.

Preferred Chat Room Restrictions

There are three basic assumptions that are implemented in a preferred embodiment of the present invention. First, the present invention preferably implements four chat rooms per game, Beginner, Intermediate, Expert, and Casual, and only “lightly” polices, or controls, chat room access. Such policing is preferably performed based on a player's skill level as determined by the system. Players of any skill level can enter the Casual chat room, but players are otherwise restricted to their own skill level or an immediately neighboring skill level when entering other chat rooms.

Given this first assumption, it is possible to enumerate a set of opponent profile skill assumptions, as shown in Table 1, below. In Table 1, the Players' Skill Levels column refers to all the players seated at a bench. Thus entry 1, “Beg” means that all players at that bench are of Beginner skill. Entry 2, “Beg, Int” means that some players are Beginners and some are Intermediates.

TABLE 1

| | Players' Skill | Player Seated | Opponent Profile |
|---|---|---|---|
| | Levels | in Chat Room | Skill Assumption |
| 1 | Beg | Beginner | Beg—Beg |
| 2 | Beg, Int | Beginner | Beg-Int |
| 3 | Beg, Exp | Beginner | Cannot Happen |
| 4 | Beg, Int, Exp | Beginner | Cannot Happen |
| 5 | Int | Beginner | Beg-Int |
| 6 | Int, Exp | Beginner | Cannot Happen |
| 7 | Exp | Beginner | Cannot Happen |
| 8 | Beg | Intermediate | Beg-Int |
| 9 | Beg, Int | Intermediate | Beg-Int |
| 10 | Beg, Exp | Intermediate | Beg-Exp |
| 11 | Beg, Int, Exp | Intermediate | Beg-Exp |
| 12 | Int | Intermediate | Int—Int |
| 13 | Int, Exp | Intermediate | Int-Exp |
| 14 | Exp | Intermediate | Int-Exp |
| 15 | Beg | Expert | Cannot Happen |
| 16 | Beg, Int | Expert | Cannot Happen |
| 17 | Beg, Exp | Expert | Cannot Happen |
| 18 | Beg, Int, Exp | Expert | Cannot Happen |
| 19 | Int | Expert | Int-Exp |
| 20 | Int, Exp | Expert | Int-Exp |
| 21 | Exp | Expert | Exp—Exp |
| 22 | Beg | Casual | Beg-Exp |
| 23 | Beg, Int | Casual | Beg-Exp |
| 24 | Beg, Exp | Casual | Beg-Exp |
| 25 | Beg, Int, Exp | Casual | Beg-Exp |
| 26 | Int | Casual | Beg-Exp |
| 27 | Int, Exp | Casual | Beg-Exp |
| 28 | Exp | Casual | Beg-Exp |

The present invention preferably enforces this assumption by policing the rooms. By way of example, without intending to limit the present invention, a player of Beginner skill can only enter the Beginner, Intermediate and Casual chat rooms. A player of Beginner skill level will preferably be blocked from entering an Expert level chat room until his or her skill has at least reached the ‘Intermediate’ level. This is indicated by the “Cannot Happen” entries in Table 1.

A second assumption implemented in a preferred embodiment is that chat rooms are typically implemented without geographical restrictions, meaning that players from one geographic region can communicate with players from other geographic regions, without restrictions. A player who enters a chat room can therefore be seen as implying that he or she is not interested in restricting game play to those opponents in a particular geographic region. Thus, a preferred interoperation method assumes that chat room players are interested in “World” location, or that chat room players are not interested in restricting their opponents to those in a particular geographic region.

Finally, even though a subscriber's Block List is preferably part of his or her identity information, a preferred embodiment of the present invention ignores a player's Block List for chat rooms searches. This is typical for chat rooms because if a first player does not wish to play with another in the same room, the first player can always leave the room or decline entry into a particular game instance (referred to as a “bench”).

While each of the above assumptions is implemented in a preferred embodiment of the present invention to provide more organized, orderly, and efficient player matching means, it should be apparent to one skilled in the art that additional limitations may be added to further simplify the operation of the invention without departing from the spirit or the scope of the present invention. In addition, it should be clear to one skilled in the art that assumptions such as those above need not be inherent parts of the system, and that changes may be made to the assumptions, including removing or substituting assumptions, without departing from the spirit or the scope of the present invention.

Determining Opponent Profile Information

A preferred first step in chat room interoperation is to deduce opponent profile information from information previously available to the present invention and in the chat room. Information determined for chat room searchers includes, but is not limited to, desired skill level or skill level range, language, and location.

To facilitate explaining the operation of the present invention, it is perhaps simplest to begin with consideration of a typical chat room as it is populated with the three players described in Table 2.

TABLE 2

| | | | |
|---|---|---|---|
| Name | Alan | Bob | Chuck |
| Skill level | Beginner | Beginner | Intermediate |

It is assumed that the players of Table 2 sit at benches as described below:

TABLE 3
chat rooms

| Room Name | Beginner | | Beginner | |
|---|---|---|---|---|
| BENCHES | Bench # | Players | Bench # | Players |
| | 100 | Alan | 101 | Bob |

That is, Alan and Bob are each sitting at separate benches in a Beginner room. For the time being, it is assumed that Chuck has not yet chosen to sit down.

The present invention preferably makes restrictive assumptions regarding opponent profile information. Specifically, since both Bob and Alan are Beginners, as determined from their identity information, and are sitting in Beginner chat rooms, the present invention assumes that the skill range of opponents Bob and Alan presently prefer is Beg-Beg. If Chuck were to sit down at Bob's bench, the resulting room structure would resemble Table 4, below.

TABLE 4
chat rooms

| | | | | |
|---|---|---|---|---|
| Room Name | Beginner | | Beginner | |
| BENCHES | Bench # | Players | Bench # | Players |
| | 100 | Alan | 101 | Bob, |
| | | | | Chuck |

When Chuck sits down at Bench 101, Bob may not know that Chuck is an Intermediate skill player, but the system will now refine its assumptions with respect to the room members. Specifically, the present invention now preferably assumes that Bob and Chuck are willing to play against opponents in the Beg-Int skill range as indicated from line 2 in Table 1.

Had Chuck chosen to sit at a bench by himself, the resulting room structure would resemble that shown in Table 5, below.

TABLE 5
chat rooms

| Room Name | Beginner | | Beginner | | Beginner | |
|---|---|---|---|---|---|---|
| BENCHES | Bench # | Players | Bench # | Players | Bench # | Players |
| | 100 | Alan | 101 | Bob | 102 | Chuck |

As the room structure of Table 5 shows, the present invention would still assume Alan and Bob are looking for Beg-Beg opponents, whereas the present invention would assume that Chuck is looking for Beg-Int opponents.

Language

Language is treated a little differently than skill level because players can speak multiple languages. The system tracks this in their identity information through the use of two fields, primary language and additional languages. Primary language is a single language, preferably the language in which the player is most proficient, whereas additional languages can have zero or more entries.

Language Implementation

One chat room interoperating embodiment uses only the primary language field of those sitting at a bench to determine the language of the bench, and of the room containing the bench. If all players sitting at a bench have the same language in their primary language field then that bench is assumed to be in a room for that language. For example, if the players defined in Table 6 were to join a chat room and sit at benches as shown in Table 7, the system would assume Bench 100 is an English language bench because Alan and Bob both speak English as their primary language. Similarly, the present invention assumes that bench 101 is a Spanish language bench.

TABLE 6

| | | | |
|---|---|---|---|
| Name | Alan | Bob | Carlos |
| Primary Language | English | English | Spanish |

If it is further assumed that Alan and Bob sit at the same bench, and Carlos sits at a different bench, a room structure similar to Table 7 will likely result, with the implied language for Bench 100 being English and the implied language for bench 101 being Spanish.

TABLE 7
chat rooms

| | | | | |
|---|---|---|---|---|
| Room Name | Intermediate | | Intermediate | |
| BENCHES | Bench # | Players | Bench # | Players |
| | 100 | Alan, | 101 | Carlos |
| | | Bob | | |

On the other hand, if the players at a bench have a different language in their primary language field, the system assumes any language is acceptable. For example, if, as illustrated in Table 8, Carlos were to sit at a bench with Bob, the present invention would assume Bench 100 is an English language bench and bench 101 is ANY (indicative of any language being acceptable).

TABLE 8
chat rooms

| Room Name | Intermediate | | Intermediate | |
|---|---|---|---|---|
| BENCHES | Bench # | Players | Bench # | Players |
| | 100 | Alan | 101 | Bob, Carlos |

Alternative Language Determination Algorithm

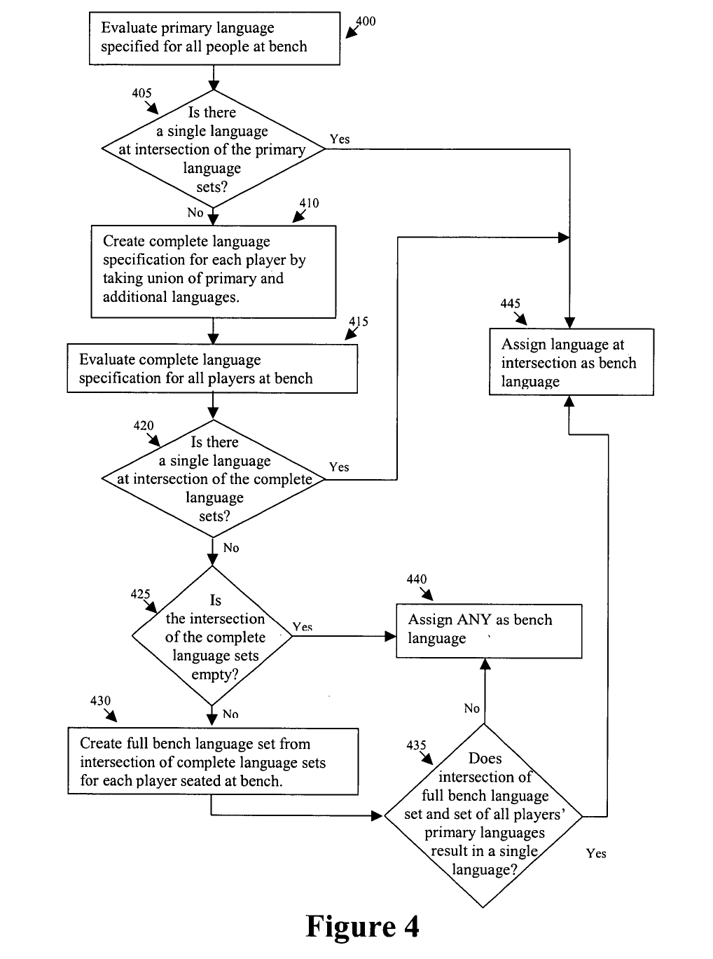

An alternative bench or room language determination algorithm is illustrated in FIG. 4. As FIG. 4 illustrates, this algorithm begins by evaluating the primary language specified for all players sitting at a given bench (Block 400). If all players at the bench are shown to have the same primary language, i.e. the intersection of the primary language sets for all players at the bench is a single language (Block 405), then that language is assigned as the bench's language (Block 445).

If all players at the bench do not have the same primary language, then a complete language specification is created for each player (Block 410). The complete language specification consists of a union of the primary language and additional languages specified by the player and stored in the player's player information. The resulting complete language specifications are then analyzed against each other (Block 415). If there is a single language at the intersection of the complete language sets (Block 420), then that language is assigned as the bench language (Block 445). If the intersection of the complete language specification sets results in an empty set (Block 425), then the bench is assumed to not have a language preference, and ANY is assigned as the bench language. If the intersection of the complete language specification sets results in multiple languages, then processing proceeds to Block 430.

In Block 430, a full bench language set is created from the languages in the intersection of the complete language sets for each player. It should be obvious to one skilled in the art that a proper language set to select for the bench is one of the languages in the full bench language set. To choose from among the languages in the full bench language set, the full bench language set is compared to the set of all players' primary languages (Block 435). If the intersection of these two sets results in a single language, that language is assigned to the bench (Block 445). If no languages are in the intersection of the two sets, or if the intersection results in multiple languages, then ANY is preferably assigned as the bench language (Block 440). However, it should be apparent to one skilled in the art that alternative language selection methods, including, but not limited to, randomly choosing from among any of the common bench languages or selecting the language most frequently appearing as a bench language is an acceptable alternative to assigning ANY to the bench.

Location

As previously discussed, the present invention assumes that players in chat rooms are not interested in placing geographic restrictions on the set of persons from whom the present invention can select an opponent or opponents. Thus, each room, and each bench within a room, is treated as though its location is World. In addition, it is presently preferred to only match players in one or more chat rooms with those Automatic Searchers who are also not interested in placing geographical restrictions on the set of opponents.

In an alternative embodiment, location can be treated in a manner similar to skill level. Such an embodiment would provide a floating range of locations depending on the players seated at a bench. For example, if Alan is from Los Angeles and is sitting by himself at a bench in a chat room, the present invention may create a room structure in which Alan appears in a Los Angeles-only room, a California-only room, a United States only room, and the world room. If Bob, from New York, were to sit at Alan's bench, then the system would remove Alan's LA-only, and California-only rooms, since Bob and Alan only have USA and World locations in common.

To allow location information to be treated in this manner requires the system to search the auto search rooms multiple times for each additional chat room player. It is anticipated that such searches will result in a system that is four to six times slower than a World-only level search. This alternative embodiment will require additional processing time per user, which effectively decreases the number of users who can be handled by a server at a given time, and thus increases overall system cost. Thus, this alternative embodiment is not presently preferred, although as processor speeds increase, such an embodiment may be advantageous.

Adding a Chat Room Player to Automatic Opponent Matching

The preceding methods can be used to determine opponent profile information from player seating arrangement in a chat room. Once such information has been determined, it can be used in matching players in conjunction with the Automatic Opponent Matching system. Description of the interoperation of the Automatic Opponent Matching and chat room systems is described below. Although the description below does not describe how each possible state should be handled by the present invention, resolution of any issues not specifically covered below should be readily understood by one skilled in the art without undue experimentation.

The examples that follow track system operations for a typical four player game, although it should be apparent to one skilled in the art that the system and methods described herein are readily adaptable to games of any number of players without departing from the spirit or the scope of the present invention. At first, language is held constant and various skill level scenarios are described. Afterward, skill level is held constant and various language scenarios are described. The total effect is the combination of these two pieces which should be apparent to one skilled in the art.

Seating a New Chat Room Player (Base Example)

For the purposes of this explanation, it is assumed that the players defined in Table 9 are looking for opponents via the Automatic Opponent Matching system.

TABLE 9

| | | | | | | |
|---|---|---|---|---|---|---|
| Name | Ab | | Bb | | Ci | |
| Language | English | Any | English | Any | English | Any |
| Skill | Beg | Beg-Int | Beg | Beg-Int | Int | Beg-Int |

| | | | |
|---|---|---|---|
| ID | Profile ID | Profile ID | Profile |

If these players join the Automatic Opponent Matching portion of the present invention, a room structure similar to that shown in Table 10 will result.

TABLE 10
Auto Search Rooms

| | | | | | | |
|---|---|---|---|---|---|---|
| Language | Any | | Any | | Any | |
| Skill | Beg-Beg | | Beg-Int | | Int-Int | |
| BENCHES | Bench # | Players | Bench # | Players | Bench # | Players |
| | 1 | Ab, Bb | 2 | Ab, Bb, | 3 | Ci |
| | | | | Ci | | |

If Doug, a player of Beginner skill, joins the present invention, he can do so by sitting at a bench in any room, as long as the previously described policing system does not foreclose that room to him. In a preferred embodiment, players joining the system and wishing to enter a chat room may only select from the set of chat rooms available to them, and may not be aware that other chat rooms exist. In an alternative embodiment, all available chat rooms are enumerated to the player, but access to the chat rooms is restricted. In such an alternative embodiment, a player may be made aware that he or she cannot enter a chat room or chat rooms by use of visual or auditory clues, such as bold fonts, highlighting, sound effects, and the like. For the purposes of the present example, it is assumed that Doug chooses to sit at a bench in the Beginner chat room, which results in a room structure similar to that of Table 11.

TABLE 11
chat rooms

| Room Name | Beginner | |
|---|---|---|
| BENCHES | Bench # | Players |
| | 100 | Doug |

Immediately upon sitting down at this bench, Doug's view of the system is as shown above. The system will quickly update this view to include others in the chat room, but before the view is updated, the system scans the Automatic Opponent Matching system to see if there are any players there who can fill out Doug's bench. This is preferable over populating Doug's bench with alternative persons in the chat room because those in the Automatic Opponent Matching system are interested in starting a game as quickly as possible, whereas those in a chat room may not be as anxious to begin a game. Since Doug is a Beginner in a Beginner chat room the system assumes that Doug's opponent profile is looking for Beg-Beg opponents. Adding Ab, Bb, and Ci the room structure of Table 11 results in a room structure similar to that of Table 12 in the Automatic Opponent Matching system.

TABLE 12
Auto Search Rooms

| Language | Any | | Any | | Any | |
|---|---|---|---|---|---|---|
| Skill | Beg-Beg | | Beg-Int | | Int-Int | |
| BENCHES | Bench # | Players | Bench # | Players | Bench # | Players |
| | 1 | Ab, Bb, | 2 | Ab, Bb, | 3 | Ci |
| | | Doug | | Ci | | |

Since a complete four player bench has not been made, Bench 100 is presented to the rest of the players in the Beginner chat room, as shown in Table 11, and the room structure of the Automatic Opponent Matching system continues as shown in Table 12.

Seating a Second Chat Room Player (A)

Building on the room structure of Table 11, assume a player Chad, who is also of Beginner skill and who wishes to chat and/or play with other Beginners, enters the chat room system. If Chad decides to sit at Bench 100 along with Doug, a room structure similar to Table 12 will result.

TABLE 12
chat rooms

| Room Name | Beginner | |
|---|---|---|
| BENCHES | Bench # | Players |
| | 100 | Doug, Chad |

Chad's view of the system is as shown above, but before this view is updated to the other players in the chat room area the system preferably first scans the Automatic Opponent Matching system to see if there are any players there who can fill out Doug and Chad's bench. Since all players at Bench 100 are Beginners in a Beginner chat room the system assumes the opponent profile is for Beg-Beg opponents. The result of this process is shown in Table 13.

TABLE 13
Auto Search Rooms

| Language | Any | | Any | | Any | |
|---|---|---|---|---|---|---|
| Skill | Beg-Beg | | Beg-Int | | Int-Int | |
| BENCHES | Bench # | Players | Bench # | Players | Bench # | Players |
| | 1 | Ab, Bb, | 2 | Ab, Bb, | Ci | |
| | | Doug, | | Ci | | |
| | | Chad | | | | |

Since a match is found the view of Bench 100 in the chat room sees players Ab and Bb quickly seated and then the game is begun. The four players are handed off to game play server 180 and both Bench 100 of the chat room server and bench 1 of the Automatic Opponent Matching server (which are now duplicates of each other) are removed from their respective databases.

Seating a Second Chat Room Player (B)

Building on the base example of Table 11, this time it is assumed that Chad enters the chat room system but sits at his own bench. Again, Chad is a Beginner looking for opponents in the Beginner chat room.:

TABLE 14
chat rooms

| Room Name | Beginner | |
|---|---|---|
| BENCHES | Bench # | Players |
| | 100 | Doug |
| | 101 | Chad |

Chad's view of the system is as shown in Table 14 above, but before this view is updated to the other players in the chat room area the system preferably first scans the Automatic Opponent Matching system to see if there are any players there who can fill out Chad's bench. Since all players at bench 101 are Beginners in a Beginner chat room the system assumes the opponent profile is for Beg-Beg opponents. The result of this process is shown in Table 15.

TABLE 15
Auto Search Rooms

| Language | Any | | Any | | Any | |
|---|---|---|---|---|---|---|
| Skill | Beg-Beg | | Beg-Int | | Int-Int | |
| BENCHES | Bench # | Players | Bench # | Players | Bench # | Players |
| | 1 | Ab, Bb, | 2 | Ab, Bb, | 3 | Ci |
| | | Doug | | Ci | | |
| | 4 | Ab, Bb, | | | | |
| | | Chad | | | | |

Since a complete four player bench has not been made, bench 101 is presented to the rest of the players in the Beginner chat room as shown in Table 14, and the Room structure of the Automatic Opponent Matching system continues as shown in Table 15.

Seating a Second Chat Room Player With a Blocked List Restriction

From the base example of Table 11, it is now assumed that Chad appears on player Ab's blocked list, and it is assumed that Doug and Chad are seated at the same bench, as shown in Table 16.

TABLE 16
chat rooms

| Room Name | Beginner | |
|---|---|---|
| BENCHES | Bench # | Players |
| | 100 | Doug, Chad |

An attempt to add Chad to bench 1 fails because Ab will not play with Chad. It is important to note that, because Chad and Doug may be communicating with each other, it is preferred to keep Chad and Doug together. Thus, bench 1 is split in a manner similar to how blocked lists are handled in the Automatic Opponent Matching invention. The main difference is that the additional restriction that Chad and Doug remain together (be treated as a single unit) is preferably imposed. The result is shown in Table 17.

TABLE 17
Auto Search Rooms

| Language | Any | | Any | | Any | |
|---|---|---|---|---|---|---|
| Skill | Beg-Beg | | Beg-Int | | Int-Int | |
| BENCHES | Bench # | Players | Bench # | Players | Bench # | Players |
| | 1 | Ab, Bb | 2 | Ab, Bb, | 3 | Ci |
| | | | | Ci | | |
| | 4 | Bb, Doug, | | | | |
| | | Chad | | | | |

A preferred rule for splitting these player groups is: First the newly added group ({Doug, Chad} in this case) is removed and the remaining group ({Ab, Bb} in this case) is placed at one bench. Next, the newly added group is assigned to a new bench and each member of the remaining group individually is tested and added to the new bench only if it is okay to add them to this new bench. Here Ab fails this test because Ab does not want to play with Chad, therefore Ab is not added. However, Bb passes the test and thus is added to the bench. The result is bench 4, as shown in Table 17. Since a complete four player bench has not been made, Bench 100 is presented to the rest of the players in the Beginner chat room, as shown in Table 16, and the Room structure of the Automatic Opponent Matching system continues as shown in Table 17.

Seating Players With Room Scope Change (A)

In this example, a chat room player is first placed at a Beg-Beg bench, which is subsequently modified into a Beg-Int bench. This example requires a different set-up from the examples above. For this example, it is assumed that the players described in Table 18 are looking for opponents via the Automatic Opponent Matching system.

TABLE 18

| | | | | |
|---|---|---|---|---|
| Name | Ab | | Bi | |
| Language | English | Any | English | Any |
| Skill | Beg | Beg—Beg | Int | Beg-Int |
| | ID | Profile | ID | Profile |

When these players join the system, a room structure similar to Table 19 results within the Automatic Opponent Matching system.

TABLE 19
Auto Search Rooms

| Language | Any | | Any | | Any | |
|---|---|---|---|---|---|---|
| Skill | Beg-Beg | | Beg-Int | | Int-Int | |
| BENCHES | Bench # | Players | Bench # | Players | Bench # | Players |
| | 1 | Ab | 2 | Bi | 3 | Bi |

Player Doug now enters the present invention. It is assumed that Doug's identity information states that he is a Beginner, and, for the purposes of this example, that Doug has chosen to sit at a bench in the Beginner chat room, as shown in Table 20.

TABLE 20
chat rooms

| Room Name | Beginner | |
|---|---|---|
| BENCHES | Bench # | Players |
| | 100 | Doug |

Immediately upon sitting down at Bench 100, Doug's view of the system is as shown in Table 20, but before this view is updated to the other players in the chat room area, the system preferably first scans the Automatic Opponent Matching system to see if there are any players there who can fill out Doug's bench. Since Doug is a Beginner in a Beginner chat room the system assumes that Doug's opponent profile is looking for Beg-Beg opponents. The result of this process within the Automatic Opponent Matching system is shown in Table 21.

TABLE 21
Auto Search Rooms

| Language | Any | | Any | | Any | |
|---|---|---|---|---|---|---|
| Skill | Beg-Beg | | Beg-Int | | Int-Int | |
| BENCHES | Bench # | Players | Bench # | Players | Bench # | Players |
| | 1 | Ab, Doug | 2 | Bi | 3 | Bi |

Since a complete four player bench has not been made, Bench 100 is presented to the rest of the players in the Beginner chat room, as shown in Table 20, and the Room structure of the Automatic Opponent Matching system continues as shown in Table 21.

Chad now enters our system. For the purposes of the present example, it is assumed that Chad's identity information states that he is an Intermediate skill level player but he chooses to sit at Doug's bench in the Beginner chat room.

TABLE 22
chat rooms

| Room Name | Beginner | |
|---|---|---|
| BENCHES | Bench # | Players |
| | 100 | Doug, Chad |

Chad's view of the system is as shown in Table 22, but before this view is updated to the other players in the chat room area, the present invention scans the Automatic Opponent Matching system to see if there are any players there who can fill out Doug and Chad's bench. However, unlike the previous example, the players at Bench 100 are now Beginners and Intermediates. The system therefore assumes the opponent profile is for Beg-Int opponents. The benches in the Automatic Opponent Matching room structure need to be modified accordingly. The result of this process is shown in Table 23.

TABLE 23
Auto Search Rooms

| Language | Any | | Any | | Any | |
|---|---|---|---|---|---|---|
| Skill | Beg-Beg | | Beg-Int | | Int-Int | |
| BENCHES | Bench # | Players | Bench # | Players | Bench # | Players |
| | 1 | Ab | 2 | Bi, Doug, | 3 | Bi |
| | | | | Chad | | |

As should be apparent from comparing Tables 21 and 23, the present invention removes Doug from Bench 1 since it now appears Doug's opponent profile is not Beg-Beg, but rather Beg-Int. Also, it's clear Chad's opponent profile is Beg-Int and this leaves Bench 2 as the only place for both Doug and Chad.

A complete four player bench has not been made, thus Bench 100 is presented to the rest of the players in the Beginner chat room, as shown in Table 22, and the room structure of Table 23 persists in the Automatic Opponent Matching system.

Seating Players With Room Scope Change (B)

This example builds upon the Automatic Opponent Matching system room structure shown in Table 10. For the purposes of this example, it is assumed that Chad enters the chat room system with Doug already there, and that Chad chooses to sit at Doug's bench, as shown in Table 24. For the purposed of this example, it is also assumed that both the minimum and maximum number of players for the given game is four.

TABLE 24
chat rooms

| Room Name | Beginner | |
|---|---|---|
| BENCHES | Bench # | Players |
| | 100 | Doug, Chad |

Chad's view of the system is as shown in Table 24, but before this view is updated to the other players in the chat room area the system preferably first scans the Automatic Opponent Matching system to see if there are any players there who can fill out Doug and Chad's bench. The players at Bench 100 are now Beginners and Intermediates. The system assumes the opponent profile is for Beg-Int opponents. The benches in the Automatic Opponent Matching system room structure need to be modified accordingly. The result of this process is shown in Table 25.

TABLE 25
Auto Search Rooms

| | | | | | | |
|---|---|---|---|---|---|---|
| Language | Any | | Any | | Any | |
| Skill | Beg—Beg | | Beg-Int | | Int—Int | |
| BENCHES | Bench # | Players | Bench # | Players | Bench # | Players |
| | 1 | Ab, Bb | 2 | Ab, Bb, | 3 | Ci |
| | | | | Ci | | |
| | | | 4 | Doug, | | |
| | | | | Chad | | |

Doug and Chad are preferably treated as a group, and Bench 2 has only one opening, therefore Doug and Chad cannot sit there, and therefore a new bench is made for them. This is an unusual situation because Ab, Bb, and Ci do not yet know that they are waiting for only one additional player. Any two of them would be happy to play with Doug and Chad, but the fact that they entered the system before Doug and Chad results in them not being matched up. If Ab, Bb, Ci entered the system after Doug and Chad then the first two of them would have made a game with Doug and Chad and the third would be left waiting for other opponents.

It should be apparent to one skilled in the art that it is mathematically possible to analyze the above situation and arrive at a four person bench. As server processor speeds increase it may be advisable to implement such a scheme without significantly impacting speed or efficiency, but at the present time, the above-described method is preferred.

Language

In addition to skill level matching, the present invention can also match players based on the language or languages they speak. The following examples describe how a preferred embodiment of the present invention implements skill level matching. These examples are based predominantly on the three players whose language information is presented in Table 26.

TABLE 26

| | | | |
|---|---|---|---|
| Name | Alan | Bob | Carlos |
| Primary Language | English | English | Spanish |

Same Language

If Alan and Bob sit at the same chat room bench while Carlos sits at a different bench, the chat room structure would resemble Table 27.

TABLE 27
chat rooms

| Room Name | Intermediate | |
|---|---|---|
| BENCHES | Bench # | Players |
| | 100 | Alan, Bob |
| | 101 | Carlos |

The room structure below shows how the players from Table 26 would be represented in an Automatic Opponent Matching system.

TABLE 28
Auto Search Rooms

| Language | English | | Spanish | |
|---|---|---|---|---|
| Skill | Int—Int | | Int—Int | |
| BENCHES | Bench # | Players | Bench # | Players |
| | 1 | Alan, Bob | 2 | Carlos |

Different Language

On the other hand, if Bob and Alan were already seated at different benches, as shown in Table 29, before Carlos joined the system, the Automatic Opponent Matching system room structure would resemble Table 30.

TABLE 29
chat rooms

| Room Name | Intermediate | |
|---|---|---|
| BENCHES | Bench # | Players |
| | 100 | Alan |
| | 101 | Bob |

TABLE 30
Rooms

| Language | English | |
|---|---|---|
| Skill | Int—Int | |
| BENCHES | Bench # | Players |
| | 1 | Alan |
| | 2 | Bob |

If Carlos subsequently joins the system and decides to sit at Bob's bench, the chat room structure will resemble Table 31.

TABLE 31
chat rooms

| Room Name | Intermediate | |
|---|---|---|
| BENCHES | Bench # | Players |
| | 100 | Alan |
| | 101 | Bob, Carlos |

In addition, Bob would be removed from Bench 2 in the Automatic Opponent Matching room structure, and a new bench with ANY as the language would be created:

TABLE 32
Auto Search Rooms

| Language | English | | Any | |
|---|---|---|---|---|
| Skill | Int-Int | | Int-Int | |
| BENCHES | Bench # | Players | Bench # | Players |
| | 1 | Alan | 3 | Bob, Carlos |

Switched Language Example A

In this example, the system reevaluates it's language assumption and changes it. Here the system initially assumes English is the bench language, but with the arrival of Carlos, the bench language switches to ANY. To further clarify the operation of the system in such an event, the following describes how the system reacts when there is an automatic searcher sitting at the bench with Bob.

Initially, the chat room view and Automatic Player Matching room structure are the same as in Tables 29 and 30, as shown in Tables 33 and 34.

TABLE 33
chat rooms

| Room Name | Intermediate | |
|---|---|---|
| BENCHES | Bench # | Players |
| | 100 | Alan |
| | 101 | Bob |

TABLE 34
Auto Search Rooms

| Language | English | |
|---|---|---|
| Skill | Int-Int | |
| BENCHES | Bench # | Players |
| | 1 | Bob |
| | 2 | Alan |

It is now assumed that player Aeng joins the system and wishes to play against someone speaking English, while Bany wishes to play against someone speaking any language. The resulting Automatic Player Matching room structure will resemble Table 35.

TABLE 35
Auto Search Rooms

| Language | English | | Any | |
|---|---|---|---|---|
| Skill | Int-Int | | Int-Int | |
| BENCHES | Bench # | Players | Bench # | Players |
| | 1 | Bob, Aeng | 3 | Bany |

| | |
|---|---|
| 2 | Alan |

If Carlos subsequently sits at the bench with Bob, the chat room view will resemble Table 36.

TABLE 36
chat rooms

| Room Name | Intermediate | |
|---|---|---|
| BENCHES | Bench # | Players |
| | 100 | Bob, Carlos |
| | 101 | Alan |

In the chat room view shown in Table 36, the present invention adjusts its expectation of language for Bench 100 and changes it to ANY. The effect on the Automatic Player Matching room structure is shown in Table 37.

TABLE 37
Auto Search Rooms

| Language | English | | Any | |
|---|---|---|---|---|
| Skill | Int-Int | | Int-Int | |
| BENCHES | Bench # | Players | Bench # | Players |
| | 1 | Aeng | 3 | Bany, Bob, Carlos |

| | |
|---|---|
| 2 | Alan |

In a preferred embodiment, bench 1 is treated as if Bob made a game at another bench or modified his search criteria. Thus, Bob is deleted from bench 1 and no attempt is made to match Aeng with bench 2. This operation is described in more detail in the Automatic Opponent Matching application. An alternative embodiment may incorporate additional logic to match up potential opponents such as Alan and Aeng.

As the room structure of Table 37 is reevaluated to accommodate the changed language specification for Bob and Carlos, they are added as a unit to bench 3 as described in Skill-level matching above. Bench 3 has at least 2 open seats, and it is the first bench the search algorithm discovers that has sufficient seats and qualities for Bob and Carlos, therefore they are placed there.

This same method is preferably used for any language change, regardless of the type of language change. Thus, whether the change is from one language to ANY, or from one language to another language, the same method is used.

Switched Language-B

It is possible for languages to switch back, that is to go from Any to English or from English to Spanish back to English again. Both are handled in a manner similar to that described above, as the system merely views it as an individual language change. This example illustrates this behavior.

Initially the chat room view and Automatic Player Matching room structure are as shown in Table 38 and 39, respectively.

TABLE 38
chat rooms

| Room Name | Intermediate | |
|---|---|---|
| BENCHES | Bench # | Players |
| | 100 | Alan, Carlos |
| | 101 | Bob |

TABLE 39
Auto Search Rooms

| Language | Any | | English | |
|---|---|---|---|---|
| Skill | Int-Int | | Int-Int | |
| BENCHES | Bench # | Players | Bench # | Players |
| | 1 | Alan, | 2 | Bob |
| | | Carlos | | |

If player Aeng enters the system and wishes to play against someone speaking English, while Bany wishes to play against someone speaking any language, an Automatic Opponent Matching room structure similar to Table 40 will result.

TABLE 40
Auto Search Rooms

| Language | Any | | English | |
|---|---|---|---|---|
| Skill | Int-Int | | Int-Int | |
| BENCHES | Bench # | Players | Bench # | Players |
| | 1 | Alan, Carlos, Bany | 2 | Bob, Aeng |

If Carlos decides he no longer wishes play the game and leaves Alan's bench, the chat room view will resemble Table 41.

TABLE 41
chat rooms

| Room Name | Intermediate | |
|---|---|---|
| BENCHES | Bench # | Players |
| | 100 | Alan |
| | 101 | Bob |

The system subsequently adjusts its room language expectation and changes it to English. The effect on the Automatic Opponent Matching room structure is shown in Table 42.

TABLE 42
Auto Search Rooms

| Language | Any | | English | |
|---|---|---|---|---|
| Skill | Int-Int | | Int-Int | |
| BENCHES | Bench # | Players | Bench # | Players |
| | 1 | Bany | 2 | Bob, Aeng |
| | | | 3 | Alan |

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

We claim as our invention:

1. An opponent matching method for facilitating game play, comprising:
establishing at least one chat room in which a first set of prospective opponents can meet;
creating at least one bench within each chat room;
storing information about the first set of prospective opponents meeting in each of the at least one chat rooms in a first database;
evaluating the prospective opponents at each of the at least one benches and building assumptions with respect to the prospective opponents at each bench;
establishing a second set of prospective opponents who wish to play a game as quickly as possible;
storing information about the second set of prospective opponents in a second database;
comparing the prospective opponents in the second set of prospective opponents to the assumptions made with respect to each bench;
assigning at least one prospective opponent from the second set of prospective opponents to a bench based on the results of the comparing step; and,
initiating a game when at least a minimum number of players have been assigned to a bench.

2. The opponent matching method of claim 1, wherein the information stored about the first set of prospective opponents includes prospective opponent skill levels, and the information stored about the second set of prospective opponents also includes prospective opponent skill levels.

3. The opponent matching method of claim 2, wherein the at least one chat rooms are established based on prospective opponent skill levels.

4. The opponent matching method of claim 3, further comprising controlling access to each of the at least one chat rooms based on the skill level of a prospective opponent.

5. The opponent matching method of claim 4, wherein the information stored about the first set of prospective opponents further includes a Blocked List.

6. The opponent matching method of claim 5, wherein prospective opponent Block Lists are ignored when controlling access to the at least one chat rooms.

7. The opponent matching method of claim 2, wherein assumptions built with respect to the prospective opponents at a bench are restrictive assumptions.

8. A chat room bench language evaluation method, comprising:
establishing the set of primary languages specified for each prospective opponent at a bench;
assigning the language at the intersection of the primary language sets for all prospective opponents at the bench as the language for the bench if a single language exists at the intersection of the primary language sets, and ending evaluation under the method;
establishing the complete set of languages, for each prospective opponent at the bench;
assigning the language at the intersection of the complete language sets for all prospective opponents at the bench as the language for the bench if a single language exists at the intersection of the complete language sets, and ending evaluation under the method;
assigning ANY as the language for the bench.

9. The chat room bench language evaluation method of claim 8, further comprising creating a full bench language set from the intersection of the complete language sets for each prospective opponent at the bench, assigning the language at the intersection of the full bench language set and the set of all primary languages specified by the prospective opponents at the bench if a single language appears in the set intersection, and ending evaluation under the method.

10. The chat room bench language evaluation method of claim 8, further comprising selecting a language at random from the set of languages at the intersection of the complete language sets.

11. An opponent matching system for matching prospective game participants, and thus facilitating playing a game, comprising:
a game definition, wherein the game definition includes a minimum number of players necessary to initiate a game;
a plurality of game participant devices, wherein each of the plurality of game participant devices is operated by a prospective game participant;
at least one game participant information database, wherein the at least one game participant information database contains information about each of the prospective game participants, including game participant skill level;
at least one chat room for each game participant skill level defined in the at least one game participant information database;
at least one auto searchers database, wherein the at least one auto searchers database contains at least one game bench for each of the game participant skill levels defined in the at least one game participant information database, and wherein each of the at least one game bench lists prospective game participants who are not interested in participating in the at least one chat room;
at least one chat room searchers database, wherein the at least one chat room searchers database contains at least one table, wherein the at least one table contains a list of prospective game participants using each of the at least one chat rooms;
at least one game participant selection server, wherein the at least one game participant selection server monitors the at least one chat room searchers database and the at least one auto searchers database, and matches prospective game participants listed in the at least one auto searchers database with prospective game participants participating in the at least one chat room to facilitate game play; and,
a communications means, for coupling the plurality of game participant devices to the at least one game participant selection server.

12. The opponent matching system of claim 11, wherein the plurality of game participant devices includes at least one wireless device.

13. The opponent matching system of claim 12, wherein the at least one wireless device is a cellular telephone.

14. The opponent matching system of claim 12, wherein the at least one wireless device is a personal desktop assistant.
